(19) United States
(12) Patent Application Publication
(10) Pub. No.: US 2020/0259294 A1
(43) Pub. Date: Aug. 13, 2020

(54) ROBUST, COMPACT ELECTRICAL CONNECTOR

(71) Applicant: Amphenol East Asia Ltd., Taoyuan City (TW)

(72) Inventor: Lo-Wen Lu, Taoyuan City (TW)

(73) Assignee: Amphenol East Asia Ltd., Taoyuan City (TW)

(21) Appl. No.: 16/556,728

(22) Filed: Aug. 30, 2019

Related U.S. Application Data
(60) Provisional application No. 62/802,619, filed on Feb. 7, 2019.

(51) Int. Cl. H01R 13/631; H01R 12/57; H01R 12/71; H01R 13/516

(52) U.S. Cl. CPC H01R 13/631; H01R 12/57; H01R 2107/00; H01R 13/516; H01R 12/716

(57) ABSTRACT

An electrical connector includes a housing having a bottom and at least one wall bounding, at least in part, an opening adjacent the bottom; an island protruding from the bottom of the housing and into the opening; a plurality of terminals supported by the island; and at least one guide post extending from the bottom of the housing and into the opening. Each guide post is spaced apart from the island. The connector may further include a shell surrounding an outer surface of the housing. The shell may include a first portion conforming with the outer surface and a plurality of second portions spaced apart from the outer surface and bounding spaces between the outer surface and the shell.

### FIELD OF THE INVENTION

This disclosure relates generally to electrical interconnection systems and more specifically to compact electrical connectors.

### BACKGROUND

Electrical connectors are used in many electronic systems. In general, various electronic devices (e.g., smart phones, tablet computers, desktop computers, notebook computers, digital cameras, and the like) have been provided with assorted types of connectors whose primary purpose is to enable an electronic device to exchange data, commands, and/or other signals with one or more other electronic devices. Electrical connectors are basic components needed to make some electrical systems functional. Signal transmission to transfer information (e.g., data, commands, and/or other electrical signals) often utilize electrical connectors between electronic devices, between components of an electronic device, and between electrical systems that may include multiple electronic devices.

It is generally easier and more cost effective to manufacture an electrical system as separate electronic assemblies, such as printed circuit boards (“PCBs”), which may be communicatively joined together with electrical connectors. In some scenarios, the PCBs to be joined may each have connectors mounted on them. The connectors may be mated together directly to interconnect the PCBs.

In other scenarios, the PCBs may be connected indirectly via a cable. Electrical connectors may nonetheless be used to make such connections. For example, the cable may be terminated on one or both ends with a plug type of electrical connector (“plug connector” herein). A PCB may be equipped with a receptacle type of electrical connector (“receptacle connector” herein) into which the plug connector may be inserted to connect the cable to the PCB. A similar arrangement may be used at the other end of the cable, to connect the cable to another PCB, so that signals may pass between the PCBs via the cable.

### SUMMARY

According to some aspects of the present technology, an electrical connector is provided. The connector may include a housing comprised of a bottom and at least one wall bounding, at least in part, an opening adjacent the bottom. The connector also may include an island protruding from the bottom into the opening, and a plurality of terminals supported by the island. The connector also may include a first guide post extending from the bottom into the opening. The first guide post may be spaced apart from the island.

In an aspect, the connector may include a second guide post extending from the bottom into the opening. The second guide post may be spaced apart from the island.

In an aspect, the opening is rectangular, and the first and second guide posts are disposed at diagonally opposite corners of the opening.

In an aspect, the opening may have a longer dimension and a shorter dimension orthogonal to the longer dimension, and the island may be elongated along the longer dimension. The first guide post may be situated between a first end of the island and an adjacent wall of the at least one wall.

In an aspect, the adjacent wall may be a first wall extending along the shorter dimension of the opening.

In an aspect, the first wall be comprised of a notch aligned with the island.

In an aspect, the at least one wall may each have a first surface facing the opening and a second surface facing opposite the first surface. The connector may further include a metal shell adjacent the second surface(s) of the at least one wall. The shell may have a notch aligned with the notch of the first wall.

In an aspect, the connector may further include a second guide post between an end of the island and a second wall of the at least one wall. The second wall may extend along the shorter dimension.

In an aspect, the plurality of terminals may each be comprised of a mounting portion, a tail, and an intermediate portion joining the tail and the mounting portion. The mounting portions may be disposed within the bottom, and the tails may be exposed within the opening.

In an aspect, the connector may be arranged in combination with a mating connector. The mating connector may be comprised of a mating interface disposed within the opening, and two holes in which the first and second guide posts are received. The mating interface may include a slot in which the island is received.

In an aspect, a height of the first guide post or a height of the second guide post or a height of the first and second guide posts, as measured perpendicularly from the bottom of the housing, may be greater than a height of one or more of the at least one wall of the housing, as measured perpendicularly from the bottom of the housing.

In an aspect, a height of the first guide post or a height of the second guide post or a height of the first and second guide posts, as measured perpendicularly from the bottom of the housing, may be greater than a height of the island, as measured perpendicularly from the bottom of the housing.

According to some aspects of the present technology, an electrical connector is provided. The connector may include an insulative housing comprised of a bottom and a wall extending from the bottom at a periphery of the bottom. The connector also may include an island protruding from the bottom and spaced apart from the wall. The island may support a plurality of electrical terminals. The connector also may include a first guide post extending from the bottom and spaced apart from the wall and the island.

In an aspect, the connector may include a second guide post extending from the bottom of the housing and spaced apart from the wall and the island. The first and second guide posts may be positioned on opposite sides of the housing.

In an aspect, the first and second guide posts may be positioned proximate diametrically opposite internal corners of the bottom of the housing.

In an aspect, the first and second guide posts may be elongate and may extend respectively through first and second holes in the bottom of the housing.

In an aspect, the island may protrude from a first surface of the bottom of the housing. Each of the first and second guide posts may be comprised of a ledge portion that abuts against a second surface, opposite the first surface of the bottom of the housing.

In an aspect, the first and second guide posts are formed of metal.

In an aspect, the wall of the housing includes a plurality of wall portions surrounding the island. The connector may further include a shell surrounding the plurality of walls. The shell may be comprised of a first portion that conforms with an outer surface of the wall of the housing, and a plurality of second portions spaced apart from the outer surface of the wall of the housing.

In an aspect, each of the second portions of the shell may bound a space between an outer surface of the insulative housing, and each of the second portions of the shell may be configured to receive a leg of a mating connector therein.

In an aspect, the plurality of wall portions may be comprised of first and second longer walls and first and second shorter walls. The second portions of the shell be may located along one or both of the first and second longer walls. The first portion of the shell may conform with outer surfaces of the first and second shorter walls and outer surfaces of the first and second longer walls except at the second portions, such that the first portion has first and second longer sides and first and second shorter sides. The first shorter wall may include a first wall notch extending through a thickness of the wall, and the first shorter side of the first portion of the shell may include a first shell notch extending through a thickness of the shell. The first wall notch may be aligned with the first shell notch to form a collective first notch. The second shorter wall may include a second wall notch extending through the thickness of the wall, and the second shorter side of the first portion of the shell may include a second shell notch extending through the thickness of the shell. The second wall notch may be aligned with the second shell notch to form a collective second notch.

In an aspect, the first notch and the second notch may be configured to receive an alignment tab therein.

In an aspect, the first and second guide posts may be configured to be received respectively in first and second guide holes of a mating connector.

In an aspect, the first and second guide posts may be configured such that the mating connector is aligned by the first and second guide posts before the mating connector makes physical contact with the island.

In an aspect, the connector may include a shell surrounding the wall of the housing. The shell may be comprised of a first portion configured to conform with an outer surface of the wall of the housing, and a plurality of second portions spaced apart from the outer surface of the wall of the housing so as to bound spaces between the outer surface of the housing and the shell. Each of the spaces may be configured to receive a mating leg of the mating connector therein.

In an aspect, the second portions of the shell may enable the mating connector to achieve a general alignment with the housing before or simultaneously with alignment of the first and second guide posts with the first and second guide holes of the mating connector.

In an aspect, the connector may be a receptacle connector, and the mating connector may be a plug connector.

In an aspect, the shell may include first and second extensions projecting respectively from the first and second shorter sides of the shell. The first and second extensions may be configured to connect with a printed circuit board.

In an aspect, the wall of the housing may be comprised of a plurality of wall portions surrounding the island. The plurality of wall portions may be comprised of a plurality of recessed portions on outer surfaces of the plurality of wall portions, and the shell may be comprised of a plurality of engagement projections configured to engage with the plurality of recessed portions of the plurality of walls.

In an aspect, a height of the first guide post or a height of the second guide post or a height of the first and second guide posts, as measured perpendicularly from the bottom of the housing, may be greater than a height of the wall of the housing, as measured perpendicularly from the bottom of the housing.

In an aspect, a height of the first guide post or a height of the second guide post or a height of the first and second guide posts, as measured perpendicularly from the bottom of the housing, may be greater than a height of the island, as measured perpendicularly from the bottom of the housing.

According to some aspects of the present technology, an electrical connector is provided. The connector may be comprised of an insulative member, and an island protruding from a surface of the insulative member. The island may supporting a plurality of electrical terminals. The connector also may be comprised of first and second guide posts extending from the surface of the insulative member and spaced apart from the island. The first and second guide posts may be positioned on opposite sides of the insulative member. The connector also may be comprised of a shell surrounding the insulative member. The shell may include a first portion conforming with an outer surface of the insulative member, and a plurality of second portions spaced apart from the outer surface of the insulative member so as to bound spaces between the outer surface of the insulative member and the shell, to receive projections from a mating connector.

In an aspect, each of the spaces bounded by the second portions of the shell is a mating hole configured to receive a leg of a mating connector therein.

In an aspect, the insulative member may include first and second holes. The first and second guide posts may be elongate and may be configured to extend respectively through the first and second holes.

In an aspect, the island may protrude from a first surface of the insulative member. Each of the first and second guide posts may include a ledge portion that abuts against a second surface of the insulative member, opposite the first surface of the insulative member.

In an aspect, the first and second guide posts may be formed of metal.

In an aspect, the first and second guide posts may be structured to be received respectively in first and second guide holes of a mating connector.

In an aspect, the first and second guide posts may be structured such that the mating connector is aligned by the first and second guide posts before the mating connector makes physical contact with the island.

In an aspect, the spaces bounded by the second portions of the shell may enable the mating connector to achieve a general alignment with the insulative member before or simultaneously with alignment of the first and second guide posts with the first and second guide holes of the mating connector.

In an aspect, the connector may be a receptacle connector, and the mating connector may be a plug connector.

In an aspect, a height of the first guide post or a height of the second guide post or a height of the first and second guide posts, as measured perpendicularly from a bottom surface of the insulative member, may be greater than a height of the outer surface of the insulative member, as measured perpendicularly from the bottom surface of the insulative member.

In an aspect, a height of the first guide post or a height of the second guide post or a height of the first and second guide posts, as measured perpendicularly from a bottom surface of the insulative member, may be greater than a height of the island, as measured perpendicularly from the bottom surface of the insulative member.

According to some aspects of the present technology, a method of mating a plug connector and a receptacle connector is provided. The method may comprise: engaging at least one guide post extending from a housing bottom of the receptacle connector with at least one guide hole of the plug connector; inserting the at least one guide post into the at least one guide hole; engaging an island extending from the housing bottom with a recessed portion of the plug connector after commencing the inserting of the at least one guide post into the at least one guide hole; and inserting the island into the recessed portion. The island may support a plurality of electrical receptacle terminals exposed on an outer surface of the island. The recessed portion may support a plurality of electrical plug terminals exposed on a surface of the recessed portion and configured to engage with the receptacle terminals when the plug connector and the receptacle connector are in a mated position. The inserting of the at least one guide post into the at least one guide hole may align the island with the recessed portion.

In an aspect, the method may further comprise: prior to the inserting of the at least one guide post into the at least one guide hole, engaging a plurality of legs extending from the plug connector with a plurality of shell spaces in the receptacle connector; and inserting the legs of the plug connector into the shell spaces of the receptacle connector. Each shell space may be located between a shell of the receptacle connector and an outer surface of a housing wall of the receptacle connector. The shell spaces may enable the recessed portion of the plug connector to achieve a general alignment with the island of the receptacle connector before or simultaneously with the engaging of the at least one guide post with the at least one guide hole.

In an aspect, the plug connector may be aligned by the engaging of the at least one guide post with the at least one guide hole before the recessed portion of the plug connector makes physical contact with the island of the receptacle connector.

The foregoing features may be used, separately or together in any combination, in any of the embodiments discussed herein.

### BRIEF DESCRIPTION OF DRAWINGS

Various aspects and embodiments of the present technology disclosed herein are described below with reference to the accompanying figures. It should be appreciated that the figures are not necessarily drawn to scale. Items appearing in multiple figures may be indicated by the same reference numeral. For the purposes of clarity, not every component may be labeled in every figure.

FIG. 1 is a top perspective view of a plug connector and a receptacle connector in an engaged or mated state, in accordance with some embodiments of the present technology.

FIG. 2 is a top perspective view of the plug connector and the receptacle connector of FIG. 1 in a disengaged state, in accordance with some embodiments of the present technology.

FIG. 3 is a top perspective view of a receptacle connector, in accordance with some embodiments of the present disclosure.

FIG. 4 is a top plan view of the receptacle connector of FIG. 3.

FIG. 5 is a bottom plan view of the receptacle connector of FIG. 3.

FIGS. 6A and 6B are front and back elevational views of the receptacle connector of FIG. 3.

FIGS. 7A and 7B are left-side and right-side elevational views of the receptacle connector of FIG. 3.

FIG. 8 is a top perspective view of the receptacle connector of FIG. 3, in a partially disassembled state.

FIG. 9 is a top perspective view of the receptacle connector of FIG. 3, in a partially disassembled state.

FIG. 10 is a top perspective view of the plug connector of FIG. 2, in a partially disassembled state.

FIG. 11 is a bottom perspective view of the plug connector of FIG. 2.

FIG. 12 is a perspective view of a contact assembly of a receptacle connector, in accordance with some embodiments of the present technology.

FIG. 13 is a perspective view of terminals of the contact assembly of FIG. 12.

### DETAILED DESCRIPTION

The inventors have also recognized and appreciated design techniques for electrical connectors that enable mated plug and receptacle connectors to occupy a small volume while providing reliable operation for high-integrity signal interconnects. Techniques and technology described herein may lead to compact yet robust connectors, which are less likely to be damaged during mating.

The inventors have further recognized and appreciated that, although each metal terminal of a receptacle connector has been carefully soldered onto a PCB during the production of the receptacle connector, during use the receptacle connector will be mated with another connector (e.g., a plug connector). It is preferred that, during mating, the direction of applied force be parallel to the axial direction of the receptacle connector. However, in practice, a user may not pay special attention to the angle at which the plug connector is inserted into the receptacle connector. Thus, the receptacle connector may be subject to an external force that is not parallel to the axial direction of the receptacle connector, thus potentially causing the receptacle connector to tilt. In some situations, the force may be sufficient to separate one or more of the metal terminals from the PCB, rendering the receptacle connector unable to perform its interconnection functions, which in turn affects the normal operation of the electronic device in which the receptacle connector is used.

The inventors have recognized and appreciated that, when a user seeks to insert a plug connector into a receptacle connector, improper orientation of the plug connector or misalignment between the plug and receptacle connectors can lead a user to place a large amount of force on the receptacle connector as the user seeks to force the plug connector into a mated position with the receptacle connector. When a plug connector is incorrectly inserted into a receiving portion of a receptacle connector, one or both of the receptacle connector and the plug connector may be permanently damaged.

For example, when a user attempts to insert a misaligned plug connector, the receptacle connector may be subject to a large force, such as up to 55 N or more. For miniaturized electrical connectors, in addition to the damage to the solder connections of the metal terminals, discussed above, the force may be sufficient to deform or break one or more portions of an insulative housing of the receptacle connector, including a portion bounding the receiving portion. The receptacle connector may then cease to be able to hold the plug connector reliably, thus creating the possibility of intermittent disconnection between the plug and receptacle connectors. Consequently, the receptacle connector may lose its functionality and, in turn, normal operation of the electronic device employing the receptacle connector may cease.

Aspects of the techniques and technology described herein may reduce or eliminate the possibility of improper orientation of a plug connector during a mating operation with a receptacle connector. Aspects of the techniques and technology described herein may reduce or eliminate the possibility of misalignment between the plug and receptacle connectors. Aspects of the techniques and technology described herein may minimize or eliminate the application of damaging forces during a mating operation.

### EMBODIMENT 1

According to a first embodiment, an electrical connector includes a housing having a bottom and at least one wall bounding, at least in part, an opening adjacent the bottom; an island protruding from the bottom into the opening; a plurality of terminals supported by the island; and a first guide post extending from the bottom of the housing and into the opening. The first guide post may be spaced apart from the island.

In an aspect of the embodiment, the electrical connector may include a second guide post extending from the bottom into the opening. The second guide post may be spaced apart from the island.

In an aspect of the embodiment, the opening may be rectangular. The first and second guide posts may be disposed at diagonally opposite corners of the opening.

In an aspect of the embodiment, the opening may have a longer dimension and a shorter dimension orthogonal to the longer dimension. The island may be elongate along the longer dimension. The first guide post may be positioned between a first end of the island and an adjacent wall of the at least one wall.

In an aspect of the embodiment, the adjacent wall may be a first wall extending along the shorter dimension. The first wall may include a notch aligned with the island.

In an aspect of the embodiment, each of the at least one wall may have a first surface facing the opening and a second surface opposite the first surface. The electrical connector may further include a metal shell adjacent the second surface of each of the at least one wall. The shell may have a notch aligned with the notch of the first wall.

In an aspect of the embodiment, the second guide post may be positioned between an end of the island and a second wall of the at least one wall extending along the shorter dimension.

In an aspect of the embodiment, each of the terminals may include a mounting portion, a tail, and an intermediate portion joining the tail and the mounting portion. The mounting portions may be disposed within the bottom, and the mounting portions may be exposed in order to be, e.g., solder-mounted to a PCB. The tails and sections of the intermediate portions may be exposed within the opening.

In an aspect of the embodiment, the electrical connector may be arranged in combination with a mating connector. The mating connector may include a mating interface disposed within the opening, and may include two holes in which the first and second guide posts are received. The mating interface may include a slot in which the island is received.

In an aspect of the embodiment, a height of the first guide post or a height of the second guide post or a height of the first and second guide posts, as measured perpendicularly from the bottom of the housing, may be greater than a height of one or more of the at least one wall of the housing, as measured perpendicularly from the bottom of the housing.

In an aspect of the embodiment, a height of the first guide post or a height of the second guide post or a height of the first and second guide posts, as measured perpendicularly from the bottom of the housing, may be greater than a height of the island, as measured perpendicularly from the bottom of the housing.

### EMBODIMENT 2

According to a second embodiment of the present technology, an electrical connector includes an insulative housing, an island, and at least one guide post. The insulative housing has a bottom and a wall that extends from the bottom at a periphery of the bottom. The island, which is structured to accommodate and support a plurality of electrical terminals, protrudes from the bottom and is spaced apart from the wall. The wall and the island may be considered to be part of a receiving portion of the electrical connector. Each of the at least one guide post extends from the bottom and is spaced apart from the wall and the island.

In an aspect of the embodiment, the electrical connector may include first and second guide posts, each extending from the bottom of the housing, and each being spaced apart from the wall of the housing and the island. The first and second guide posts may be positioned on opposite sides of the housing. For example, the first and second guide posts may be positioned respectively near diametrically opposite internal corners of the bottom of the housing. The first and second guide posts may be structured to be received respectively in first and second guide holes of a mate connector. The first and second guide posts may be elongate in shape and may extend respectively through first and second holes in the bottom of the housing. The island protrudes outward from an interior surface of the bottom, and each of the first and second guide posts may include a ledge portion that abuts against an exterior surface opposite the interior surface of the bottom.

In an aspect of the embodiment, the guide post(s) may be formed of a rigid material such as, for example, metal.

In an aspect of the embodiment, the electrical connector may be a receptacle connector.

The guide post(s) may be structured such that, in a mating operation with a mate connector, a proper alignment with the guide post(s) occurs before the mate connector makes physical contact with the island. Thus, the guide post(s) may prevent damage to the island, the electrical terminals on the island, and/or other parts of the housing by deterring misalignment of the mate connector with the electrical connector during a mating operation. Moreover, because each of the guide post(s) is located within an interior portion of the housing, damage prevention may be achieved without increasing a size of the electrical connector.

In an aspect of the embodiment, a height of the first guide post or a height of the second guide post or a height of the first and second guide posts, as measured perpendicularly from the bottom of the housing, may be greater than a height of the wall of the housing, as measured perpendicularly from the bottom of the housing.

In an aspect of the embodiment, a height of the first guide post or a height of the second guide post or a height of the first and second guide posts, as measured perpendicularly from the bottom of the housing, may be greater than a height of the island, as measured perpendicularly from the bottom of the housing.

### EMBODIMENT 3

According to a third embodiment of the present technology, the electrical connector of the first embodiment is provided with a shell that is structured to surround the wall of the housing. The shell may be removably attached to the housing, and may be formed of a rigid material such as a metallic material.

In an aspect of the embodiment, the shell may include a conforming portion structured to conform with an outer surface of the wall, and a plurality of mating portions spaced apart from the outer surface of the wall. Each of the mating portions may be a mating hole structured to receive a mating leg of a mate connector therein.

In an aspect of the embodiment, the wall of the housing may include first and second long sides and first and second short sides. The conforming portion of the shell may include corresponding first and second long sides and first and second short sides. The mating portions of the shell may be located adjacent one or both of the first and second long sides of the wall. That is, when the shell and the housing are assembled together, all of the mating portions may be adjacent a same long side of the wall, or the mating portions may be distributed on both the first and second long sides of the wall.

The mating portions of the shell are structured to enable a mate connector to achieve a general alignment with the housing before or simultaneously with alignment of the guide post(s) with corresponding guide hole(s) of the mate connector. For example, the mating portions may be located on a same long side of the conforming portion of the shell, and may enable a user to ascertain that a mate connector is properly oriented relative to the electrical connector before attempting to align the guide post(s) with the mate connector's guide hole(s). Thus, the mating portions together with the guide post(s) may prevent damage to the island, the electrical terminals, and/or other parts of the housing by deterring misorientation and/or misalignment of the mate connector with the electrical connector during a mating operation.

Optionally, the shell may include first and second legs projecting respectively from the first and second short sides of the shell. The first and second legs may be structured to connect directly or indirectly with a circuit board of an electronic device.

Optionally, the wall of the housing may include a plurality of recessed portions on the outer surface of the wall. The shell may include a plurality of latching tabs structured to engaged with the recessed portions of the wall. The latching tabs may have a resilient property that enables the latching tabs to flex or bend when the shell and the housing are being assembled together, and to snap into place in the recessed portions when the shell and the housing are properly positioned.

### EMBODIMENT 4

According to a fourth embodiment of the present technology, the electrical connector of the second embodiment may be structured such that the first short side of the wall may include a first wall notch extending through a thickness of the wall, and the first short side of the conforming portion of the shell may include a first shell notch extending through a thickness of the shell. Similarly, the second short side of the wall may include a second wall notch extending through the thickness of the wall, and the second short side of the conforming portion of the shell may include a second shell notch extending through the thickness of the shell. When the housing and the shell are assembled together, the first wall notch may be aligned with the first shell notch to form a collective first notch, and the second wall notch may be aligned with the second shell notch to form a collective second notch.

The first and second notches may be structured to receive respective first and second alignment tabs of a mate connector therein.

Similar to the mating portions of the shell, the first and second notches of the housing and the shell are structured to enable a mate connector to achieve a general alignment with the housing before or simultaneously with alignment of the guide post(s) with corresponding guide hole(s) of the mate connector. Thus, the first and second notches together with the guide post(s) may prevent damage to the island, the electrical terminals on the island, and/or other parts of the housing by deterring misalignment of the mate connector with the electrical connector during a mating operation.

### EMBODIMENT 6

According to a sixth embodiment of the present technology, a method of mating a plug connector and a receptacle connector is provided. The method includes: engaging at least one guide post extending from a housing bottom of the receptacle connector with at least one guide hole of the plug connector; inserting the at least one guide post into the at least one guide hole; engaging an island extending from the housing bottom with a recessed portion of the plug connector after commencing the inserting of the at least one guide post into the at least one guide hole; and inserting the island into the recessed portion. The island may support a plurality of electrical receptacle terminals exposed on an outer surface of the island. The recessed portion may support a plurality of electrical plug terminals exposed on a surface of the recessed portion and configured to engage with the receptacle terminals when the plug connector and the receptacle connector are in a mated position. The inserting of the at least one guide post into the at least one guide hole may align the island with the recessed portion.

In an aspect of the embodiment, the method may further include: prior to the inserting of the at least one guide post into the at least one guide hole, engaging a plurality of legs extending from the plug connector with a plurality of shell spaces in the receptacle connector; and inserting the legs of the plug connector into the shell spaces of the receptacle connector. Each shell space may be located between a shell of the receptacle connector and an outer surface of a housing wall of the receptacle connector. The shell spaces may enable the recessed portion of the plug connector to achieve a general alignment with the island of the receptacle connector before or simultaneously with the engaging of the at least one guide post with the at least one guide hole.

In an aspect of the embodiment, the plug connector is aligned by the engaging of the at least one guide post with the at least one guide hole before the recessed portion of the plug connector makes physical contact with the island of the receptacle connector

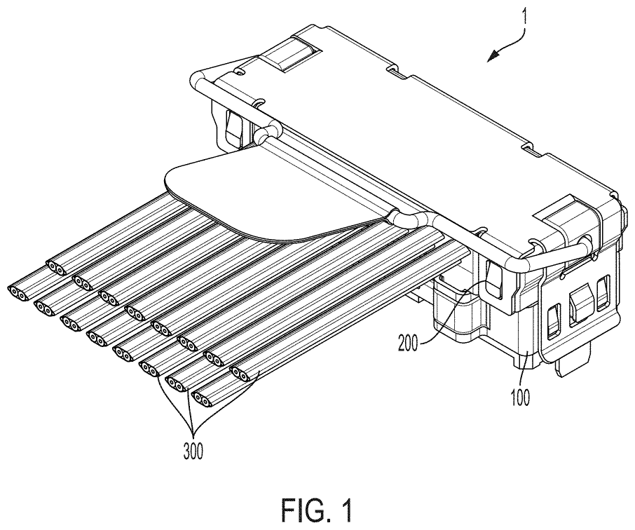

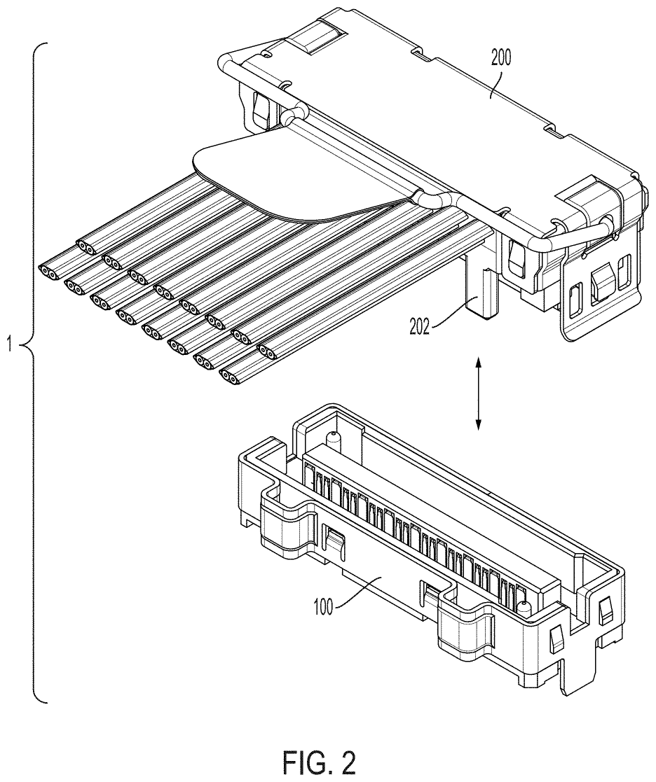

Turning now to the figures, FIG. 1 depicts an example of a mated pair 1 of electrical connectors that includes a receptacle connector 100 and a plug connector 200 connected together in an engaged or mated state, according to various embodiments of the present technology. A plurality of cables 300 extend from the plug connector 200. FIG. 2 depicts the receptacle connector 100 disengaged from the plug connector 200.

The mated pair 1 depicted in FIG. 1 provides a low-profile connection by having the cables 300 extend perpendicularly from an engagement direction of the plug connector 200 with the receptacle connector 100. In this regard, the plug connector 200 may be considered a right-angle plug connector 200. The double-headed arrow in FIG. 2 shows the engagement and disengagement directions of the mated pair 1. In the engaged or mated state (FIG. 1), the mated pair 1 enables the cables 300 to have a low profile, close to a mounting surface of a circuit board on which the receptacle connector 100 is mounted.

As will be appreciated, the receptacle connector 100 may engage with a different type of plug connector when a low profile is not necessary or desired. For example, the receptacle connector 100 may engage with a plug connector in which cables extend parallel to the engagement direction.

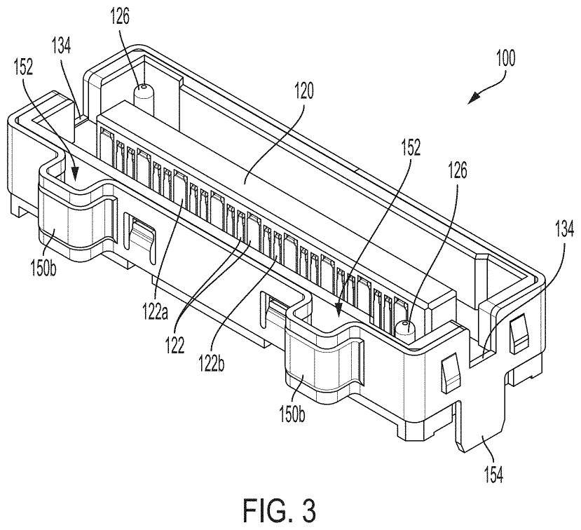

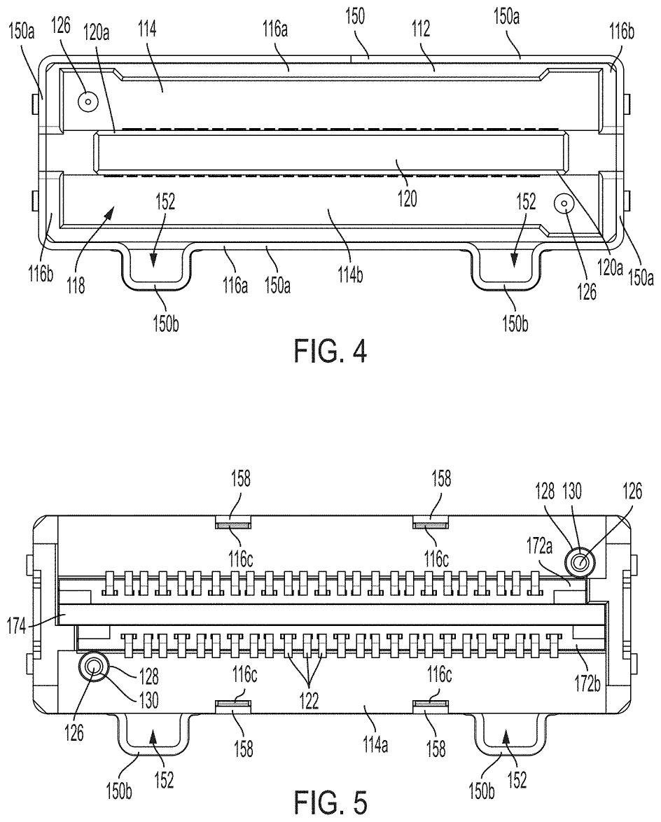

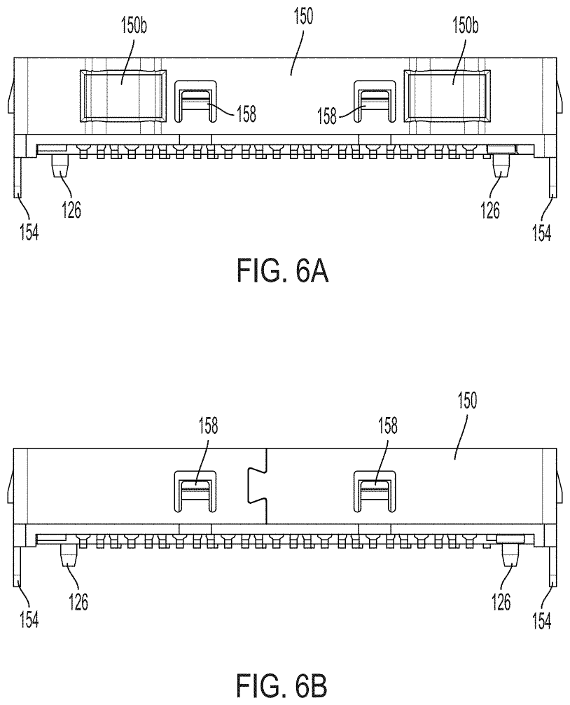

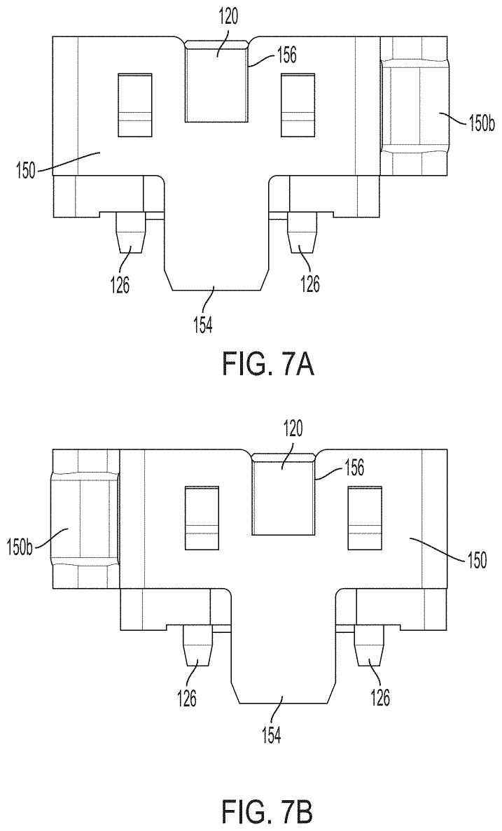

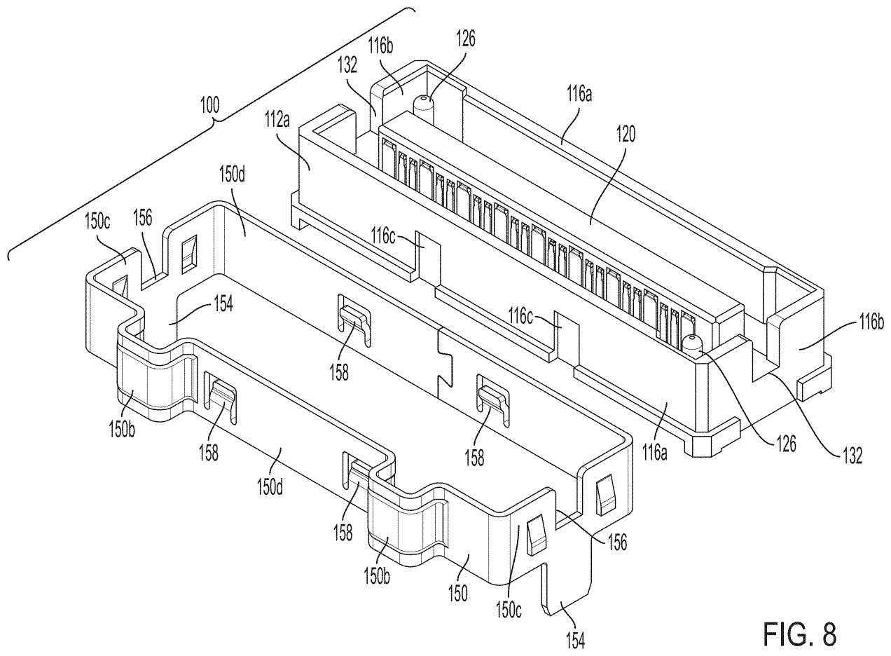

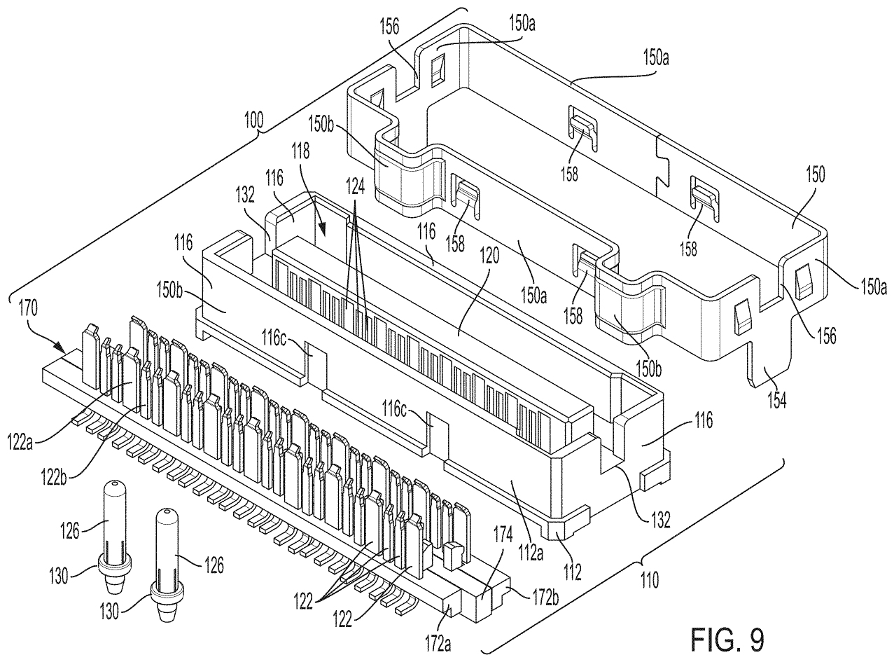

FIG. 3 shows a top-front perspective view of the receptacle connector 100. FIGS. 4 and 5 show, respectively, top and bottom plan views of the receptacle connector 100. FIGS. 6a and 6b, respectively, show front and back elevational views of the receptacle connector. FIGS. 7a and 7b, respectively, show right-side and left-side elevational views of the receptacle connector 100. FIGS. 8 and 9 show the receptacle connector 100 in different states of disassembly.

The receptacle connector 100 may include a housing assembly 110 and a shell 150. The housing assembly 110 may include an insulative housing 112 having a bottom 114 and a wall 116 extending from a periphery of the bottom 114. The bottom 114 and the wall 116 define an opening or interior 118 of the housing 112.

For example, the wall 116 may extend perpendicularly from the bottom 114 of the housing 112. The bottom 114 may have a generally rectangular shape, such that the wall 116 may have two longer sides 116a and two shorter sides 116b.

An island 120 may extend from the bottom 114 into the interior 118 of the housing 112, and may be structured to accommodate a plurality of elongate terminals 122 that include ground terminals 122a and signal terminals 122b. The island 120 may include two major surfaces 120a respectively facing the two longer sides 116a of the wall 116. One or both of the major surfaces 120a may include channels or slots 124 through which portions of the terminals 122 may be exposed.

At least one guide post 126 may extend from the bottom 114 into the interior 118 of the housing 112, and may be spaced apart from the wall 116 and the island 120. In the figures, two guide posts 126 are shown and therefore the following discussion may refer to “first and second” guideposts. However, it should be understood that the present technology may encompass a single guide post or more than two guide posts.

The guide posts 126 may extend through corresponding holes 128 in the bottom 114 of the housing 112. The guide posts 126 may each include a ledge portion 130 that abuts against an exterior surface 114a opposite an interior surface 114b of the bottom 114. The guide posts 126 may be formed of metal or another rigid material.

A height of the guide posts 126, as measured perpendicularly from the bottom 114, may be greater than a height of the wall 116, as measured perpendicularly from the bottom 114. Additionally or alternatively, the height of the guide posts 126, as measured perpendicularly from the bottom 114, may be greater than a height of the island 120, as measured perpendicularly from the bottom 114.

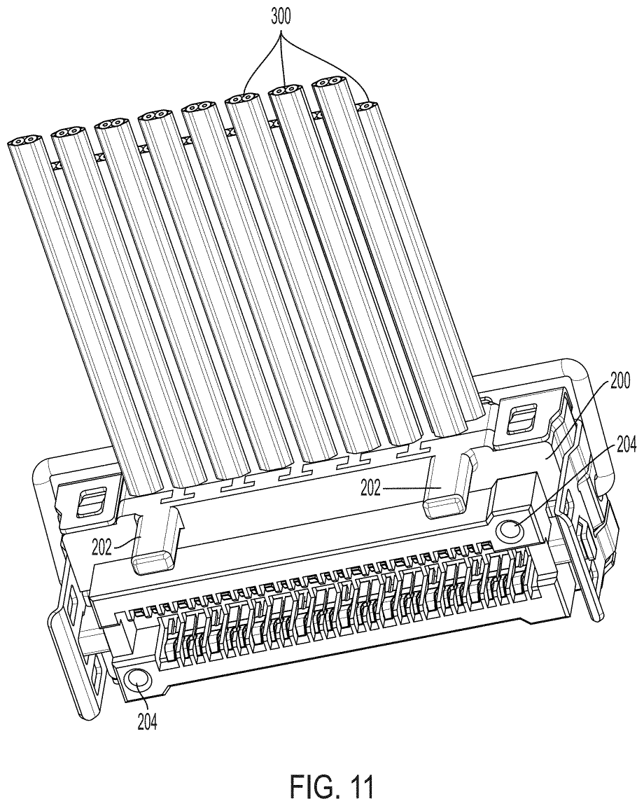

The guide posts 126 may be structured or configured to be received in corresponding guide holes 204 in a plug connector 200, as shown in FIG. 11. In a mating operation between the receptacle connector 100 and a plug connector 200, alignment with the guide posts 126 may occur before plug connector 200 makes physical contact with the island 120. This occurrence may be facilitated if the height of the guide posts 126 is greater than the height of the wall 116 and/or the height of the island 120. Thus, the guide posts 126 may prevent damage to the island 120, the terminals 122 supported by the island 120, and/or other parts of the housing 112 by deterring misalignment of the plug connector 200 with the receptacle connector 100 during a mating operation.

As shown in FIG. 4, the interior or opening 118 of the housing 112 may have a longer dimension parallel to the longer side 116a of the wall 116, and a shorter dimension orthogonal to the longer dimension and parallel to the shorter side 116b of the wall 116. The island 120 may be elongate along the longer dimension of the interior 118 of the housing 112. The guide posts 126 may be located between an end of the island 120 and an adjacent portion of the wall 116. For example, the guide posts 126 may be disposed in the housing 112 at or near diagonally opposite corners of the housing 112, respectively between diagonally opposite corners of the island 120 and diagonally opposite corners of the wall 116.

The shell 150 of the receptacle connector 100 may be configured to surround an outer surface 112a of the housing 112. The shell 150 may include at least one conforming portion 150a, which conforms with and is adjacent the outer surface 112a of the housing 112. The shell 150 may include at least one spaced-apart portion 150b, which is separated or spaced apart from the outer surface 112a of the housing 112, and which defines a space 152.

The figures show the shell 150 to include two spaced-apart portions 150b. It should be understood, however, that in various other embodiments of the present technology the shell 150 may have one spaced-apart portion 150b or more than two spaced-apart portions 150b.

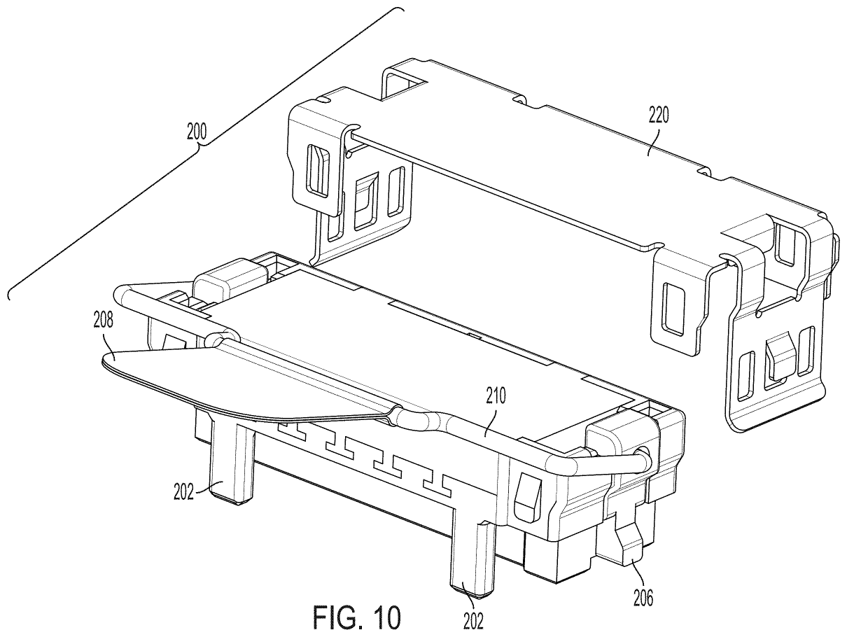

The spaces 152 defined by the spaced-apart portions 150b of the shell 150 may be structured to receive protrusions of a plug connector 200. For example, as shown in FIGS. 10 and 11, the plug connector 200 may include legs 202 arranged to be inserted in the spaces 152 in a mating operation between a plug connector 200 and the receptacle connector 100. The spaced-apart portions 150b of the shell 150 may enable the plug connector 200 to achieve a general alignment with the housing assembly 110 during an initial part of the mating operation. For example, the legs 202 of the plug connector 200 may be configured to align with and be inserted in the spaces 152 defined by the shell 150 before or simultaneously with alignment of the guide posts 126 with corresponding guide holes of the plug connector 200.

The conforming portion 150a of the shell 150 may have two shorter sides 150c adjacent the two shorter sides 116b of the wall, and may have two longer sides 150d adjacent to the two longer sides 116a of the wall 116. The conforming portion 150a may conform with the outer surface 112a of the housing 112 except at the spaced-apart portions 150b, which may be disposed along one or both of the two longer sides 150d of the shell 150. Optionally, the spaced-apart portions 150b may be disposed along one or both of the two shorter sides 150c of the shell 150, or along any combination of the two longer sides 150d and the two shorter sides 150d.

A projection tab 154 may extend from each of the two shorter sides 150c of the shell 150. The projection tabs 154 may be configured to connect with or be attached to a circuit board (not shown) on which the receptacle connector 100 is to be mounted.

One or both of the two shorter sides 116b of the wall 116 may include a notch 132 that extends through a thickness of the wall 116. One or both of the two shorter sides 150c of the shell 150 may include a notch 156 that extends through a thickness of the shell 150. The notches 132, 156 may be aligned to form a collective notch 134 in the receptacle connector 100. The collective notch 134 may be aligned with the island 120.

For example, in FIG. 3, the receptacle connector 100 is shown to include two collective notches 134. The collective notches 134 may be configured to receive alignment tabs 206 of a plug connector 200 respectively therein. FIG. 10 is a perspective view of the plug connector 200 showing one such alignment tab 206.

The alignment tabs 206 may be connected to a pull tab 208 via a handle 210 having angled ends that are pivotably attached to the alignment tabs 206, as depicted in FIG. 10. The pull tab 208 may be rotatably attached to the handle 210 such that the pull tab 208 may rotate about an axis of the handle 210. During a mating operation, the handle 210 may be pivoted to a position perpendicular to an axial position of the cables 300, to enable a user to hold and manipulate the plug connector 200 into place relative to the receptacle connector 100. Once the plug connector 200 and the receptacle connector 100 are mated together, the handle 210 may be pivoted to a position parallel to the axial position of the cables 300, such that the handle 210 does not add to a vertical height of the plug connector 200 and therefore does not adversely affect the low profile of the mated pair 1. During a detachment operation, a user may press down on the pull tab 208 (e.g., press the pull tab 208 onto the cables 300), which may cause the angled ends of the handle 210 to urge the alignment tabs 206 in a direction vertically away from the receptacle connector 100, to dislodge the plug connector 200 without applying any misoriented pressure on the receptacle connector 100 and/or the plug connector 200.

In FIG. 10, a plug shell 220 is shown separately from a plug body 230 of the plug connector 200, in order to show details of the plug body 230. As evident from FIGS. 1 and 10, the plug shell 220 may be configured to fit over the plug body 230.

Referring back to FIG. 8, the wall 116 may a plurality of recessed portions 116c that are configured to receive a plurality of latching portions 158 on the shell 150, in order to hold the shell 150 and the housing 112 together. For example, the recessed portions 116c may be disposed on the two longer sides 116a of the wall 116, and the latching portions 158 may be disposed on the two longer sides 150d of the shell 150. When the shell 150 and the housing 112 are assembled together, the latching portions 158 may latch with into the recessed portions 116c to make snap-fit connections and prevent movement of the shell 150 relative to the housing 112. The recessed portions 116c may be formed partially or completely through a thickness of the wall 116. The shell 150 may be formed of metal, and the latching portions 158 may be portions of the shell 150 that are cut and bent to form springy tabs or latches that engage with the recessed portions 116c.

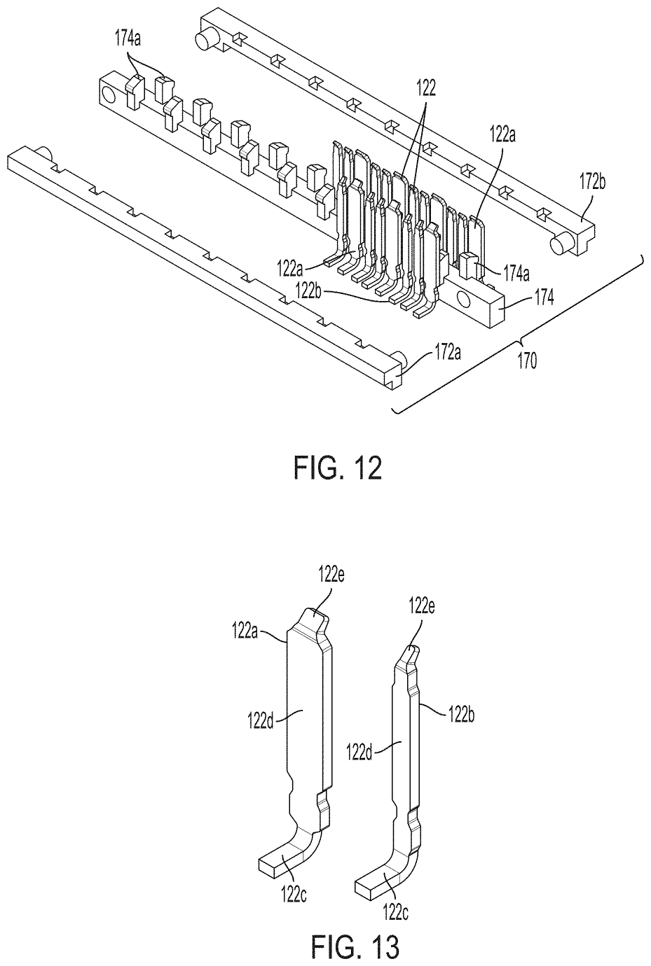

The housing assembly 110 may include a contact assembly 170 on which the terminals 122 are arranged, as depicted in FIG. 9. FIG. 12 shows a disassembled view of the contact assembly 170, with some of the terminals 122 hidden to reveal various structural aspects of the contact assembly 170. The contact assembly 170 may include first and second terminal bars 172a, 172b and a bar 174. Each terminal 122, which may be a ground terminal 122a or a signal terminal 122b, may have a mounting portion 122c, an intermediate portion 122d, and a tail 122e. The bar 174 may be formed of an electrically lossy material.

The mounting portion 122c, which may be hooked relative to the intermediate portion 122c, may configured to be mounted to a circuit board by, for example, a solder-mounting technique or another bonding technique. The tail 122e may be hooked relative to the intermediate portion 122d. In FIG. 13, the tails 122e are shown to be hooked in a first direction relative to the intermediate portions 122d, and the mounting portions 122c are shown to be hooked in a second direction generally opposite to the first direction. It should be appreciated that the configurations shown in FIG. 13 are merely examples, and the terminals 122a, 122b may have other configurations than those shown.

The mounting portion 122c may be considered a fixed end of the terminal 122, because the mounting portion 122c is intended to be fixed to a printed circuit board (not shown). In contrast, the tail 122e may be considered a distal free end of the terminal 122, because the tail 122e is not constrained but instead may move in response to a force applied to various portions of the terminal 122, including a force applied by a plug connector 200 mated which the receptacle connector 100 in which the terminal 122 is disposed. For example, the mounting portions 122c may extend through holes in the first and second terminal bars 172a, 172b, such that the mounting portions 122c may be externally exposed on the housing assembly 110 to enable solder connections, for example, to be made to the mounting portions 122c.

The terminals 122 may be arranged in two parallel rows sandwiching the bar 174 in between. The mounting portions 122c of the terminals may be configured to hook away from the bar 174. The two parallel rows of terminals 122 may be molded in place in the first and second terminal bars 172a, 172b. Optionally, the first and second terminal bars 172a, 172b may be positioned respectively against the two parallel rows of terminals 122 to hold the terminals 122 in place.

The bar 174 may include projections 174a that extend from the bar 174 and that are structured to come into contact with the ground terminals 122a.

The intermediate portions 122c and the tails 122e may extend into an interior cavity of the island 120 such that a segment of each of the terminals 122 may be exposed through the channels or slots 124 in the island 120 and may make contact with corresponding terminals in a plug connector 200.

It should be understood that various alterations, modifications, and improvements may be made to the structures, configurations, and methods discussed above, and are intended to be within the spirit and scope of the invention disclosed herein. Further, although advantages of the present invention are indicated, it should be appreciated that not every embodiment of the invention will include every described advantage. Some embodiments may not implement any features described as advantageous herein. Accordingly, the foregoing description and attached drawings are by way of example only.

It should be understood that some aspects of the present technology may be embodied as one or more methods, and acts performed as part of a method of the present technology may be ordered in any suitable way. Accordingly, embodiments may be constructed in which acts are performed in an order different than shown and/or described, which may include performing some acts simultaneously, even though shown and/or described as sequential acts in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the description and the claims to modify an element does not by itself connote any priority, precedence, or order of one element over another, or the temporal order in which acts of a method are performed, but are used merely as labels to distinguish one element or act having a certain name from another element or act having a same name (but for use of the ordinal term) to distinguish the elements or acts.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

As used herein in the specification and in the claims, the phrase “equal” or “the same” in reference to two values (e.g., distances, widths, etc.) means that two values are the same within manufacturing tolerances. Thus, two values being equal, or the same, may mean that the two values are different from one another by ±5%.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. Use of terms such as “including,” “comprising,” “comprised of,” “having,” “containing,” and “involving,” and variations thereof herein, is meant to encompass the items listed thereafter and equivalents thereof as well as additional items.

The terms “approximately” and “about” if used herein may be construed to mean within ±20% of a target value in some embodiments, within ±10% of a target value in some embodiments, within ±5% of a target value in some embodiments, and within ±2% of a target value in some embodiments. The terms “approximately” and “about” may equal the target value.

The term “substantially” if used herein may be construed to mean within 95% of a target value in some embodiments, within 98% of a target value in some embodiments, within 99% of a target value in some embodiments, and within 99.5% of a target value in some embodiments. In some embodiments, the term “substantially” may equal 100% of the target value.

What is claimed is:

1.-12. (canceled)

13. An electrical connector comprising:
a housing comprised of a bottom and a wall extending from the bottom at a periphery of the bottom;
an island protruding from the bottom of the housing and spaced apart from the wall of the housing, wherein the island supports a plurality of electrical terminals; and
a first guide post extending from the bottom of the housing and spaced apart from the wall of the housing and the island.

14. The electrical connector according to claim 13, further comprising:
a second guide post extending from the bottom of the housing and spaced apart from the wall of the housing and the island, wherein the first and second guide posts are positioned on opposite sides of the housing.

15. (canceled)

16. The electrical connector according to claim 14, wherein:
the first and second guide posts are elongate and extend respectively through first and second holes in the bottom of the housing.

17.-18. (canceled)

19. The electrical connector according to claim 13, wherein:
the wall surrounding the island is comprised of a plurality of wall portions surrounding the island,
the connector further comprises a shell surrounding the plurality of wall portions of the wall of housing, and
the shell is comprised of:
a first portion configured to conform with an outer surface of the wall of the housing, and
a plurality of second portions spaced apart from the outer surface of the wall of the housing.

20. The electrical connector according to claim 19, wherein:
each of the second portions of the shell bounds a space between an outer surface of the housing and is configured to receive a leg of a mating connector therein.

21. The electrical connector according to claim 19, wherein:
the plurality of wall portions is comprised of first and second longer walls and first and second shorter walls,
the second portions of the shell are located along one or both of the first and second longer walls,
the first portion of the shell conforms with outer surfaces of the first and second shorter walls and outer surfaces of the first and second longer walls, such that the first portion has first and second longer sides and first and second shorter sides, and such that the shell conforms with the outer surface of the wall of the housing except at the second portions,
the first shorter wall includes a first wall notch extending through a thickness of the wall, and the first shorter side of the first portion of the shell includes a first shell notch extending through a thickness of the shell, wherein the first wall notch is aligned with the first shell notch to form a collective first notch, and
the second shorter wall includes a second wall notch extending through the thickness of the wall, and the second shorter side of the first portion of the shell includes a second shell notch extending through the thickness of the shell, wherein the second wall notch is aligned with the second shell notch to form a collective second notch.

22. The electrical connector according to claim 21, wherein:
the first notch and the second notch are each configured to receive an alignment tab therein.

23. The electrical connector according to claim 14, wherein:
the first and second guide posts are structured to be received respectively in first and second guide holes of a mating connector.

24. The electrical connector according to claim 23, wherein:
the first and second guide posts are structured such that the mating connector is aligned by the first and second guide posts before the mating connector makes physical contact with the island.

25. The electrical connector according to claim 24, further comprising a shell surrounding the wall of the housing, wherein the shell is comprised of:
a first portion structured to conform with an outer surface of the wall of the housing, and
a plurality of second portions spaced apart from the outer surface of the wall of the housing so as to bound spaces between the outer surface of the housing and the shell,
wherein each of the spaces is configured to receive a leg of the mating connector therein.

26.-27. (canceled)

28. The electrical connector according to claim 20, wherein:
the shell is further comprised of first and second extensions projecting respectively from the first and second shorter sides of the shell, and
the first and second extensions are structured to connect with a printed circuit board.

29. The electrical connector according to claim 28, wherein:
the wall of the housing is comprised of a plurality of wall portions surrounding the island;
the wall portions are comprised of a plurality of recessed portions on outer surfaces of the wall portions, and
the shell is comprised of a plurality of engagement projections structured to engage with the recessed portions of the wall portions.

30. The electrical connector of claim 14, wherein:
a height of the first guide post or a height of the second guide post or a height of the first and second guide posts, as measured perpendicularly from the bottom of the housing, is greater than a height of the wall of the housing, as measured perpendicularly from the bottom of the housing.

31. The electrical connector of claim 14, wherein:
a height of the first guide post or a height of the second guide post or a height of the first and second guide posts, as measured perpendicularly from the bottom of the housing, is greater than a height of the island, as measured perpendicularly from the bottom of the housing.

32. An electrical connector comprising:
an insulative member;
an island protruding from a surface of the insulative member, wherein the island supports a plurality of electrical terminals;
first and second guide posts extending from the surface of the insulative member and spaced apart from the island, wherein the first and second guide posts are positioned on opposite sides of the insulative member; and
a shell surrounding the insulative member, the shell being comprised of:
a first portion conforming with an outer surface of the insulative member, and
a plurality of second portions spaced apart from the outer surface of the insulative member so as to bound spaces between the outer surface of the insulative member and the shell, wherein the spaces are configured to receive projections of a mating connector.

33.-36. (canceled)

37. The electrical connector according to claim 32, wherein:
the first and second guide posts are configured to be received respectively in first and second guide holes of a mating connector.

38. The electrical connector according to claim 37, wherein:
the first and second guide posts are configured such that the mating connector is aligned by the first and second guide posts before the mating connector makes physical contact with the island.

39.-40. (canceled)

41. The electrical connector of claim 32, wherein:
a height of the first guide post or a height of the second guide post or a height of the first and second guide posts, as measured perpendicularly from a bottom surface of the insulative member, is greater than a height of the outer surface of the insulative member, as measured perpendicularly from the bottom surface of the insulative member.

42. The electrical connector of claim 32, wherein:
a height of the first guide post or a height of the second guide post or a height of the first and second guide posts, as measured perpendicularly from a bottom surface of the insulative member, is greater than a height of the island, as measured perpendicularly from the bottom surface of the insulative member.

43. A method of mating a plug connector and a receptacle connector, the method comprising:
engaging at least one guide post extending from a housing bottom of the receptacle connector with at least one guide hole of the plug connector;
inserting the at least one guide post into the at least one guide hole;
engaging an island extending from the housing bottom of the receptacle connector with a recessed portion of the plug connector after commencing the inserting of the at least one guide post into the at least one guide hole; and
inserting the island into the recessed portion, wherein:
the island supports a plurality of electrical receptacle terminals exposed on an outer surface of the island,
the recessed portion supports a plurality of electrical plug terminals exposed on a surface of the recessed portion and configured to engage with the receptacle terminals when the plug connector and the receptacle connector are in a mated position, and
the inserting of the at least one guide post into the at least one guide hole aligns the island with the recessed portion.

44.-45. (canceled)
